(19) United States
(12) Patent Application Publication
(10) Pub. No.: US 2025/0307982 A1
(43) Pub. Date: Oct. 2, 2025

(54) TRANSFORMING THE PERSPECTIVE OF SENSOR DATA

(71) Applicant: TEXAS INSTRUMENTS INCORPORATED, Dallas, TX (US)

(72) Inventors: Deepak Poddar, Bangalore (IN); Pramod Swami, Bangalore (IN); Shivam Puri, Ghaziabad (IN)

(21) Appl. No.: 19/009,674

(22) Filed: Jan. 3, 2025

(30) Foreign Application Priority Data
Mar. 28, 2024 (IN) 202441025709

(51) Int. Cl. G06T 3/04; G06T 15/20

(52) U.S. Cl. CPC G06T 3/04; G06T 15/20

(57) ABSTRACT

Various embodiments of the present disclosure relate to converting sensor data from a first perspective to a second perspective, and in particular, to improving the efficiency of mapping feature data from a first perspective to a second perspective within the context of a neural network. In one example embodiment, a technique for mapping sensor data from a first perspective to a second perspective is provided. The technique first includes processing sensor data to produce a first set of feature maps associated with a first perspective. Next, the technique includes transposing the first set of feature maps to produce a first set of transposed feature maps. Once transposed, the technique includes transforming the first set of transposed feature maps into a second set of feature maps associated with a second perspective. Finally, the technique includes transposing the second set of feature maps to produce a second set of transposed feature maps.

### CROSS-REFERENCE TO RELATED APPLICATION

This application is related to, and claims the benefit of priority to, India Provisional Patent Application No. 202441025709, filed on Mar. 28, 2024, and entitled “Efficient Scattered Sum of CNN Features”, which is hereby incorporated by reference in its entirety.

### TECHNICAL FIELD

Aspects of the disclosure are related to the field of computing hardware and software and more particularly to mapping sensor data from a first perspective to a second perspective.

### BACKGROUND

A convolutional neural network (CNN) is representative of a type of deep learning architecture which is commonly employed for various computer-vision tasks, such as object detection, image classification, image segmentation, or another computer-vision task of the like. Input to a CNN includes sensor data, while the output includes feature data. For example, input to a CNN may include image data, while the output includes feature maps which were extracted from the image data. The feature maps extracted by the CNN represent vectors or matrices which assign a relevance to the various sections of the input data.

Generally, CNNs are implemented at the start or end of a deep learning network. For example, if a network is configured to perform object detection, then the network may employ a CNN to extract feature data from the input data related to the task of the network. The feature data of the CNN may then be supplied to a series of layers configured to form the output of the network.

Various networks which implement CNNs may supply the CNNs with input data represented within a first perspective, but the output of the network is represented within a second perspective. For example, a network may be configured to collect image data from a head-on perspective (i.e., front view) and convert the image data to a birds-eye view perspective (i.e., top view). In such applications, input to the CNN includes image data collected within the head-on perspective, and the output of the CNN includes feature maps captured within the head-on perspective. Output of the CNN may then be supplied to a series of layers configured to convert the feature maps from the head-on perspective to the birds-eye view perspective, or between the two perspectives.

Current techniques for mapping feature data from a first perspective to a second perspective rely on a mapping function. For example, a network configured to convert image data from a head-on perspective to a birds-eye view perspective will identify the location of feature data within the head-on perspective (i.e., source location) and map the location of the feature data to the appropriate location within the birds-eye view perspective (i.e., destination location) based on the mapping function.

Problematically, current techniques for mapping feature data are random in nature due to the method in which data is stored in memory. For example, after a node of a CNN outputs multiple feature maps within a first perspective, the CNN is configured to store the data of the first perspective feature maps based on the current dimensions of the feature maps. Meaning, the CNN is configured to store the channel data of the feature maps nonlinearly in memory. For example, the CNN may store the data of the first feature map, followed by storing the data of the second feature map, and so on.

Consequently, storing the feature maps nonlinearly in memory forces the layers subsequent to the CNN to perform nonlinear write operations when mapping the data of the feature maps from the first perspective to the second perspective. More specifically, current techniques utilize scatter operations, which causes the network to randomly map the channel data of the feature maps from the identified source location to the appropriate destination location. As a result, networks which map feature data from a first perspective to a second perspective are inefficient due to the random nature of the mapping, thereby increasing the processing times for executing the network.

### SUMMARY

Disclosed herein is technology, including systems, methods, and devices for efficiently mapping sensor data from a first perspective to a second perspective within the context of a deep learning network. In various implementations, a technique for converting sensor data from a first perspective to a second perspective is provided.

In one example embodiment, the technique first includes processing sensor data to produce a first set of feature maps associated with a first perspective. For example, the technique may include providing image data associated with a first perspective to a convolutional neural network (CNN), to cause the CNN to produce a first set of feature maps, such that the first set of feature maps are stored nonlinearly in memory.

Next, the technique includes permuting the first set of feature maps via a transpose operation to produce a first set of transposed feature maps, such that the first set of transposed feature maps are stored linearly in memory. Once permuted, the technique includes transforming the first set of transposed feature maps into a second set of feature maps, such that the second set of feature maps are associated with a second perspective and are stored linearly in the memory.

Finally, the technique includes permuting the second set of feature maps via a transpose operation to produce a second set of transposed feature maps, such that the second set of transposed feature maps are stored nonlinearly in the memory. In an implementation, after permuting the second set of feature maps, the technique further includes rendering the second set of transposed feature maps to generate an output associated with the second perspective.

This Summary is provided to introduce a selection of concepts in a simplified form that are further described below in the Technical Disclosure. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an implementation.

FIG. 2 illustrates a view transformation method in an implementation.

FIG. 3 illustrates another operational environment in an implementation.

FIG. 4 illustrates a compilation method in an implementation.

FIGS. 5A and 5B illustrate an operational scenario in an implementation.

FIG. 6 illustrates another operational environment in an implementation.

FIGS. 7A and 7B illustrate a mapping scenario in an implementation.

FIG. 8 illustrates a slicing scenario in an implementation.

FIG. 9 illustrates another mapping scenario in an implementation.

FIGS. 10A and 10B respectively illustrate a system and a table in an implementation.

FIG. 11 illustrates a computing system suitable for implementing the various operational environments, architectures, processes, scenarios, and sequences discussed below with respect to the other Figures.

### DETAILED DESCRIPTION

Technology is disclosed herein for converting sensor data from a first perspective to a second perspective within the context of a neural network which reduces the processing times for executing the network, thereby improving the network's efficiency. More specifically, technology is disclosed herein for mapping the feature data of a convolutional neural network (CNN) from a first perspective to a second perspective.

A CNN is representative of a type of deep learning architecture which utilizes convolution operations to extract features from the input data. Input to a CNN includes sensor data, while the output includes feature data extracted from the sensor data. For example, input to a CNN may include multiple image matrices which correspond to the multiple channels of an input image, while the output includes multiple feature maps which correspond to the various feature channels of the CNN.

A feature channel in the context of a CNN is representative of a convolutional filter that is applied by the nodes of the CNN to extract features from the input data. For example, the nodes of a CNN may include filters for extracting depth, colors, edges, or other characteristics of the like. Output of a feature channel is representative of a vector or matrix which stores the extracted feature data, herein referred to as a feature map. Meaning that, each node of a CNN is configured to produce a feature map for each of its feature channels and store the data of the feature maps in memory based on the dimensions of the feature maps. For example, if the output node of a CNN includes three feature channels, each configured to produce a feature map with 32 entries each, then the CNN is configured to store the 32 entries of the first feature map, then store the 32 entries of the second feature map, and then store the 32 entries of the third feature map. In other words, the CNN is configured to store the entries of the three feature maps nonlinearly in memory.

It should be noted that, each entry of a feature map corresponds to an entry within the input data. For example, if a node of the CNN is supplied with an image matrix comprising nine entries, and the node includes three feature channels, each configured to generate a feature map also comprising nine entries, then the first entry of each feature map corresponds to the first entry of the image matrix, the second entry of each feature map corresponds to the second entry of the image matrix, and so on. Thus, storing the feature map data nonlinearly in memory means the corresponding entries of the feature maps are stored non-sequentially in memory, such that the CNN is configured to store the data of the first feature map, then store the data of the second feature map, and then store the data of the third feature map, rather than storing the data from the first entries of each feature map, then storing the data from the second entries of each feature map, and so on.

Typically, CNNs are implemented within the computer-vision context. For example, a deep neural network (DNN) configured to perform object detection may employ a CNN to extract features related to the task of the DNN, and supply the extracted features to a series of layers configured to form the output of the DNN. In various applications, a DNN which employs a CNN may provide the CNN with sensor data in a first perspective, but the output of the DNN is represented within a second perspective. For example, in addition to object detection, the DNN may also be configured to convert image data from a head-on perspective (i.e., front view) to a birds-eye view (BEV) perspective (i.e., top view). In such applications, input to the CNN includes image data collected within the head-on perspective, output of the CNN includes feature maps captured within the head-on perspective, and output of the DNN includes the image data represented within the BEV perspective.

Existing techniques for mapping data from a first perspective to a second perspective rely on a mapping function. For example, a network configured to convert image data from a head-on perspective to a BEV perspective may be configured to, for each entry of each feature map, determine a location of the entry within the head-on perspective and map the location of the entry to the appropriate location within the BEV perspective via the mapping function, such that the corresponding entries of the feature maps are mapped to the same location within the BEV perspective.

Problematically, existing techniques for mapping data from a first perspective to a second perspective are inefficient due to the nature in which data is stored in memory. For example, after an output node of a CNN produces multiple feature maps, the CNN is configured to store the data of the feature maps nonlinearly in memory. Consequently, storing the data nonlinearly causes the layers subsequent to the CNN to recursively write to the same destination location, since the layers subsequent to the CNN are configured to perform scatter operations.

For example, if the output node of the CNN produces three feature maps, each comprising nine entries, then the layers subsequent to the CNN may perform at least 27 write operations since the feature data of the corresponding entries are stored nonlinearly in memory. In contrast, disclosed herein is a new technique for converting sensor data from a first perspective to a second perspective which utilizes permutation operations to linearize the feature map data in memory, and by design, improves the efficiency of networks configured to convert sensor data from a first perspective to a second perspective.

In one example embodiment a computer-readable medium having executable instructions related to converting sensor data from a first perspective to a second perspective is provided. The instructions are configured to be executed by processing circuitry, such that when executed, the instructions cause the processing circuitry to efficiently map the entries of a feature map from a first perspective to a second perspective.

In an implementation, the program instructions first cause the processing circuitry to process sensor data to produce a first set of feature maps associated with a first perspective. For example, the program instructions may cause the processing circuitry to convert image data captured within a head-on perspective into a number of image matrices, such that the number of image matrices represent the number of channels captured within the image data. Meaning that, if the input image is representative of a red-green-blue (RGB) image, then the processing circuitry may be configured to convert the image data into three matrices, such that the first matrix stores the red image data, the second matrix stores the green image data, and the third matrix stores the blue image data of the input image.

Next, the processing circuitry is configured to supply the number of image matrices to a CNN configured to generate the first set of feature maps. For example, if the CNN includes five feature channels, then the CNN is configured to generate five feature maps for the number of image matrices, such that the five feature maps are represented within the same perspective as the image matrices. In an implementation, after generating the first set of feature maps, the processing circuitry is configured to store the first set of feature maps in memory, such that the data of the feature maps is stored nonlinearly. For example, if the output node of the CNN produced five feature maps, each comprising nine entries, then when stored in memory, the CNN is configured to store the nine entries of the first feature map continuously in memory, then store the nine entries of the second feature map continuously in memory, and so on, until the CNN stores the entries of each feature map. The term “continuously” as used herein in this context means that a given group or set of entries are stored linearly together in memory.

Once stored, the program instructions cause the processing circuitry to permute the first set of feature maps to produce a first set of permuted feature maps. For example, the processing circuitry may direct an associated hardware accelerator to execute a transpose operation on the first set of feature maps to generate the first set of transposed feature maps. Once generated, the hardware accelerator is configured to store the first set of transposed feature maps in memory, such that the data of the feature maps is stored linearly in memory. For example, if the output node of the CNN produced three feature maps, each comprising 32 entries, then the hardware accelerator is configured to transpose the data of the three feature maps and store the transposed data in memory, such that the hardware accelerator is configured to store the data from the first entries of each feature map continuously in memory, then store the data from the second entries of each feature map continuously in memory, and so on, until the hardware accelerator stores the data from the 32^{nd} entries of each feature map continuously in memory.

Next, the program instructions cause the processing circuitry to transform the first set of transposed feature maps into a second set of feature maps, such that the second set of feature maps are associated with a second perspective. For example, the program instructions may cause the processing circuitry to transform the data of the transposed feature maps from a head-on perspective to a BEV perspective. In an implementation, to transform the first set of transposed feature maps into the second set of feature maps, the processing circuitry is configured to direct a view transformation engine to generate the second set of feature maps associated with the second perspective.

It should be noted that, since the second set of feature maps were generated based on the first set of transposed feature maps, the entries of the second set of feature maps are still stored linearly in memory. For example, after the view transformation engine generates the second set of feature maps, the view transformation engine is configured to store the data from the first entries of each feature map in memory, then store the data from the second entries, and so on.

Finally, the program instructions cause the processing circuitry to permute the second set of feature maps to produce a second set of permuted feature maps, such that the second set of permuted feature maps are stored nonlinearly in memory. For example, the program instructions may instruct an associated hardware accelerator to transpose the second set of feature maps to produce a second set of transposed feature maps and store the second set of transposed feature maps in memory, such that the hardware accelerator stores the entries of the first feature map, then the entries of the second feature map, and so on.

In an implementation, the program instructions further cause the processing circuitry to render the second set of permuted feature maps to generate an output of the network. For example, if the network is configured to perform object detection, and convert data from a first perspective to a second perspective, then the output of the network may include a detected object within the second perspective.

Advantageously, the proposed technology optimizes the execution of networks configured to convert sensor data from a first perspective to a second perspective by implementing permutation operations (e.g., transpose operations) to linearize the data in memory, thereby reducing the latency, processing load, and power consumption of the network. As a result, the proposed technology is more efficient than applications which exclusively store the feature data nonlinearly in memory.

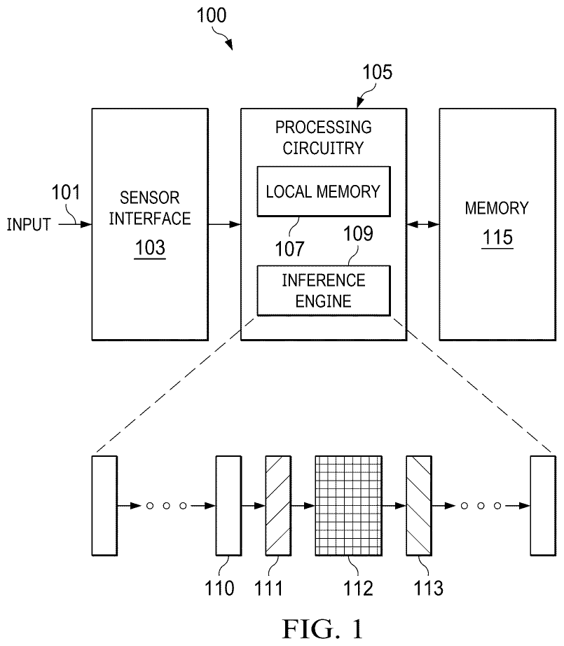

Now turning to the figures, FIG. 1 illustrates operating environment 100 in an implementation. Operating environment 100 is representative of an example environment configurable to execute the layers of a neural network. For example, operating environment 100 may be representative of a system configured to perform object detection while converting the perspective of input data from a first perspective to a second perspective. Operating environment 100 may be implemented in a variety of use-cases such as automotive, industrial, robotics, building automation, power electronics, autonomous systems, or another application of the like. Operating environment 100 includes, but is not limited to, sensor interface 103, processing circuitry 105, and memory 115.

Sensor interface 103 is representative of one or more sensors configured to collect input data for executing a neural network. For example, sensor interface 103 may be representative of cameras, radar devices, LiDAR devices, or a combination thereof configured to collect sensor data (i.e., input data 101) within a first perspective. In an implementation, sensor interface 103 represents a collection of cameras configured to collect image data within a head-on perspective, convert the image data into a readable format, and provide the formatted data to processing circuitry 105.

For example, sensor interface 103 may collect input data 101, such that input data 101 is representative of an RGB image. Next, sensor interface 103 may format input data 101 into three image matrices, such that the first image matrix stores the red pixel data of input data 101, the second image matrix stores the green pixel data of input data 101, and the third image matrix stores the blue pixel data of input data 101. Once formatted, sensor interface 103 may provide the generated image matrices to processing circuitry 105.

Processing circuitry 105 is representative of circuitry configured to execute the layers of a neural network. For example, processing circuitry 105 may be representative of a central processing unit (CPU), application-specific integrated circuit (ASIC), digital signal processor (DSP), microcontroller unit (MCU), graphics processing unit (GPU), tensor processing unit (TPU), or another general-purpose processor (GPP) of the like. Processing circuitry 105 includes, but is not limited to, local memory 107 and inference engine 109.

Local memory 107 is representative of one or more volatile or non-volatile computer-readable storage media including instructions, data, and the like. For example, local memory 107 may be representative of static random-access memory (SRAM), dynamic random-access memory (DRAM), flash memory, cache memory, or another on-chip memory of the like configured to store the data of processing circuitry 105. In an implementation, local memory 107 is configured to store the output of sensor interface 103. For example, after formatting input data 101, sensor interface 103 may store the formatted data within local memory 107. In an implementation, local memory 107 is also configured to store the output data for the layers of inference engine 109. For example, after execution of a layer, inference engine 109 may store the output data of the layer (e.g., feature map) within local memory 107.

Inference engine 109 is representative of circuitry configured to execute the layers of a neural network. For example, inference engine 109 may represent a CPU, ASIC, DSP, MCU, GPU, TPU, or another GPP of the like configured to perform the task of the associated network. In an implementation, inference engine 109 represents circuitry configured to perform a computer-vision task while converting sensor data from a first perspective to a second perspective. For example, inference engine 109 may perform object detection while converting image data which was captured within a head-on perspective, to image data captured within a birds-eye view (BEV) perspective. Inference engine 109 includes multiple layers for performing the task of the network, including, but not limited to, layer 110, permutation layer 111, view transformation layer 112, and permutation layer 113.

Layer 110 is representative of a processing layer configured to provide extracted feature data to the next layer of the network. For example, layer 110 may represent the output layer of a CNN configured to extract feature data from input data 101. More specifically, layer 110 is representative of a processing layer that include ones or more nodes configured to provide a number of feature maps to permutation layer 111, such that the number of feature maps is equal to the number of feature channels within the output nodes of layer 110.

A feature channel is representative of a filter configured to extract specific features from input data 101. For example, if inference engine 109 is configured to perform object detection, then the nodes of the CNN may include convolutional filters related to detecting edges, colors, depth, shapes, patterns, and other features of the like within input data 101. Output of the feature channels is representative of a vector or matrix which is represented within the same perspective as input data 101, herein referred to as a feature map.

In an implementation, after generating the number of feature maps, layer 110 is configured to store the data of the feature maps in memory based on the dimensions of the feature maps. For example, if the nodes of layer 110 produce four feature maps, then layer 110 is configured to store the data of the first feature map, then store the data of the second feature map, then store the data of the third feature map, and then finally store the data of the fourth feature map continuously in local memory 107. In other words, layer 110 is configured to store the data of the feature maps nonlinearly in memory. Once stored, the output data of layer 110 may be accessed by permutation layer 111.

Permutation layer 111 is representative of a processing layer configured to perform a permutation operation on the output data of layer 110. For example, permutation layer 111 may be configured to execute a transpose operation on the output data of layer 110. In an implementation, to perform the transpose operation of permutation layer 111, processing circuitry 105 is configured to offload the transpose operation to an associated hardware accelerator (not shown). For example, after storing the data of layer 110 in local memory 107, the associated hardware accelerator may be configured to transpose the data of layer 110 to generate a set of transposed feature maps. It should be noted that, the output data of permutation layer 111 is still captured within the same perspective as input data 101.

In an implementation, after transposing the number of feature maps, the associated hardware accelerator is configured to store the transposed data in memory based on the dimensions of the transposed feature maps. For example, if the output of layer 110 includes four feature maps, each comprising 16 entries, then after transposing the data of the four feature maps, the hardware accelerator is configured to store the data of the first entries of each transposed feature map, then store the data of the second entries, and so on, until the hardware accelerator stores the data of the 16^{th} entries continuously in local memory 107. In other words, the hardware accelerator is configured to store the data of the transposed feature maps linearly in memory. Once stored, the output data of transpose layer 110 may be accessed by view transformation layer 112.

It should be noted that, the hardware accelerator is able to store the data of the transposed feature maps linearly in memory due to the nature of the transpose operation. This is because transposing the data of the feature maps causes the dimensions of the feature maps to be formatted in such a way which allows the associated hardware accelerator to store the data on a channel-basis rather than sequentially storing the data of each entry of each feature map in memory.

View transformation layer 112 is representative of a processing layer configured to transform the perspective of transposed feature maps produced by permutation layer 111 from a first perspective to a second perspective. For example, view transformation layer 112 may be configured to transform the perspective of the transposed feature maps from a head-on perspective to a BEV perspective, or vice versa. In an implementation, to transform the data from the first perspective to the second perspective, view transformation layer 112 is configured to apply a mapping function to the transposed feature data to determine the appropriate location for the transposed feature data in the second perspective. Output of view transformation layer 112 includes a set of feature maps represented within the second perspective.

In an implementation, after outputting the second set of feature maps, view transformation layer 112 is configured to store the data of the second set of feature maps in memory, such that the data is stored linearly in memory. It should be noted that, since the second set of feature maps were generated based on the data of the transposed feature maps, the entries of the second set of feature maps are still stored linearly in memory. For example, after view transformation layer 112 generates the second set of feature maps, view transformation layer 112 is configured to store the first entries of the feature maps continuously in local memory 107, then the second entries, and so on. Once stored, the output data of view transformation layer 112 may be accessed by permutation layer 113.

Permutation layer 113 is representative of a processing layer configured to perform a permutation operation on the output data of view transformation layer 112. For example, permutation layer 113 may be configured to execute a transpose operation on the output data of view transformation layer 112. In an implementation, to perform the transpose operation of permutation layer 113, processing circuitry 105 is configured to offload the transpose operation to an associated hardware accelerator. For example, after storing the data of view transformation layer 112 in local memory 107, the associated hardware accelerator may be configured to transpose the data of view transformation layer 112 to generate a second set of transposed feature maps. It should be noted that, the output data of permutation layer 113 is still captured within the second perspective.

In an implementation, after transposing the output of view transformation layer 112, the associated hardware accelerator is configured to store the transposed data in memory, such that the data is stored nonlinearly. For example, if the output of view transformation layer 112 includes four feature maps, each comprising 16 entries, then after transposing the data of the four feature maps, the hardware accelerator is configured to store the data of the first feature map, then store the data of the second feature map, then store the data of the third feature map, then finally store the data of the fourth feature map continuously in local memory 107. Once stored, the output data of permutation layer 113 may be accessed by the next layer of the network.

For example, the output of permutation layer 113 may be supplied to a series of layers configured to form the output of inference engine 109. For example, if inference engine 109 is configured to perform object detection while converting image data from a head-on perspective to a BEV perspective, then the output of inference engine 109 may be representative of the detected object within the BEV perspective. In an implementation, output of inference engine 109 is stored by memory 115.

Memory 115 is representative of one or more volatile or non-volatile computer-readable storage media including instructions, data, and the like. For example, memory 115 may be representative of SRAM, DRAM, flash memory, or another off-chip memory of the like configured to store the output data of inference engine 109. In an implementation, memory 115 is further representative of a memory configured to store the output data of sensor interface 103 and the feature data of inference engine 109. For example, if local memory 107 includes a limited amount of storage space, then processing circuitry 105 may be configured to store the data of sensor interface 103 and inference engine 109 in memory 115, and when certain sections of data need to be accessed, processing circuitry 105 may read out the necessary data from memory 115 and write the data to local memory 107.

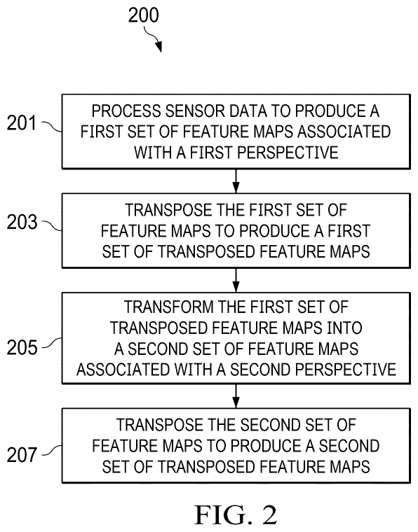

FIG. 2 illustrates view transformation method 200 in an implementation. View transformation method 200 is representative of software for converting sensor data from a first perspective to a second perspective in the context of a neural network configured to perform a task. For example, view transformation method 200 may be representative of a method for converting sensor data from a head-on perspective to a BEV perspective in the context of a network configured to perform image classification. View transformation method 200 may be implemented in the context of program instructions that, when executed by a suitable computing system, direct the processing circuitry of the computing system to operate as follows, referring parenthetically to the steps in FIG. 2. For the purposes of explanation, view transformation method 200 will be explained with the elements of FIG. 1. This is not meant to limit the applications of view transformation method 200, but rather to provide an example.

To begin, the input layers of inference engine 109 process sensor data collected by sensor interface 103 to produce a first set of feature maps associated with a first perspective (step 201). For example, sensor interface 103 may be representative of a collection of cameras configured to collect input data 101, such that input data 101 is representative of one or more RGB images captured within a head-on perspective. In an implementation, sensor interface 103 is further representative of circuitry configured to convert input data 101 into a format which may be processed by inference engine 109.

For example, if input data 101 represents three RGB images captured within the head-on perspective, then sensor interface 103 may be configured to, for each RGB image, convert the pixel data of the image into a matrix with three channels, such that the first channel represents the red pixel data, the second channel represents the green pixel data, and the third channel represents the blue pixel data. Sensor interface 103 may then supply the generated image matrices to inference engine 109, and in response, the CNN of inference engine 109 may process the image matrices to extract features related to the task of the network. For example, if inference engine 109 is representative of a network configured to perform object detection within the automotive context, then the CNN of inference engine 109 may include feature channels configured to extract features related to the detection of pedestrians, other vehicles, traffic signs, road hazards, wildlife, and other objects of the like. In an implementation, output of the CNN includes the first set of feature maps, such that the first set of feature maps are captured within the same perspective as input data 101 (e.g., head-on perspective).

Next, permutation layer 111 is configured to transpose the first set of feature maps to produce a first set of transposed feature maps (step 203). In an implementation, the transpose operation of permutation layer 111 is executed by an associated hardware accelerator. For example, after producing the first set of feature maps, inference engine 109 is configured to store the first set of feature maps in memory, such that the data of the feature maps is stored nonlinearly in the memory. Meaning that, if the CNN of inference engine 109 produces four feature maps, each comprising 16 entries, then inference engine 109 is configured to store the data of the first feature map, then store the data of the second feature map, then store the data of the third feature map, and then store the data of the fourth feature map continuously in local memory 107. Once stored, permutation layer 111 is configured to cause an associated hardware accelerator to transpose the data of the feature maps to generate the first set of transposed feature maps. The hardware accelerator is then configured to store the first set of transposed feature maps in memory, such that the data of the feature maps is stored linearly in the memory.

For example, if the first set of transposed feature maps includes four feature maps, each comprising 16 entries, then the hardware accelerator is configured to store the data of the first entries, then store the data of the second entries, then store the data of the third entries, and so on, until the hardware accelerator stores the data of the 16^{th} entries continuously in local memory 107. It should be noted that, the data of the first set of transposed feature maps is still captured within the same perspective as the input data. For example, if the input data was captured within a head-on perspective, then the first set of transposed feature maps represents feature data also captured within the head-on perspective.

Next, view transformation layer 112 is configured to transform the first set of transposed feature maps into a second set of feature maps, such that the second set of feature maps are associated with a second perspective (step 205). For example, view transformation layer 112 may be configured to convert the first set of transposed feature maps from the head-on perspective to a BEV perspective. In an implementation, to transform the data of the first set of transposed feature maps from the first perspective to the second perspective, view transformation layer 112 is configured to, for each entry of each feature map, apply a mapping function to the data of the entry to determine a location for the data within the second perspective.

It should be noted that each entry of the first set of transposed feature maps is currently represented within a source location in the first perspective. As such, view transformation layer 112 is configured to, for each source location, determine the appropriate destination location within the second perspective. Meaning, view transformation layer 112 is configured to identify the location of each entry within the first perspective and determine the appropriate location for each entry within the second perspective, based on the mapping function. Once determined, view transformation layer 112 may execute a series of gather operations to generate a second set of feature maps associated with the second perspective.

A gather operation is representative of a mapping technique which is utilized to manipulate the representation of data from a first perspective to a second perspective. For example, after view transformation layer 112 determines the appropriate destination location of each entry within the second perspective, view transformation layer 112 may, for each destination location, identify the feature data to be stored by the destination location, read the feature data from the one or more source locations, and write the feature data to the destination location. View transformation layer 112 may perform the gather operation for each destination location, and as a result, generate the second set of feature maps.

In an implementation, after generating the second set of feature maps, inference engine 109 is configured to store the second set of feature maps in memory, such that the data of the feature maps is stored linearly in the memory. For example, if view transformation layer 112 produces four feature maps, each comprising 16 entries, then inference engine 109 is configured to store the data of the first entries, then store the data of the second entries, then store the data of the third entries, and so on, until inference engine 109 stores the data of the 16^{th} entries continuously in local memory 107.

Once stored, permutation layer 113 is configured to transpose the second set of feature maps to produce a second set of transposed feature maps (step 207). In an implementation, the transpose operation of permutation layer 113 is executed by an associated hardware accelerator. For example, after storing the second set of feature maps in memory, permutation layer 113 is configured to cause an associated hardware accelerator to transpose the data of the feature maps to generate the second set of transposed feature maps.

The hardware accelerator is then configured to store the second set of transposed feature maps in memory, such that the data of the feature maps is stored nonlinearly in the memory. For example, if the second set of transposed feature maps included four transposed feature maps, each comprising 16 entries, then the hardware accelerator is configured to store the data of the first transposed feature map, then store the data of the second transposed feature map, then store the data of the third transposed feature map, and then finally store the data of the fourth transposed feature map continuously in local memory 107.

In an implementation, after storing the second set of transposed feature maps in memory, the remaining layers of inference engine 109 are configured to form the output of the network within the second perspective. For example, if inference engine 109 is configured to perform object detection within the BEV perspective, then the output of the remaining layers of inference engine 109 may include a detected object within the BEV perspective.

Advantageously, view transformation method 200 rearranges the format of data in memory via transpose operations, thereby allowing the network to perform linear write operations (i.e., gather operations) when transforming the data from the first perspective to the second perspective. As a result, view transformation method 200 provides a method which reduces the latency, processing times, and power consumption of networks configured to convert sensor data from a first perspective to a second perspective while performing a designated task.

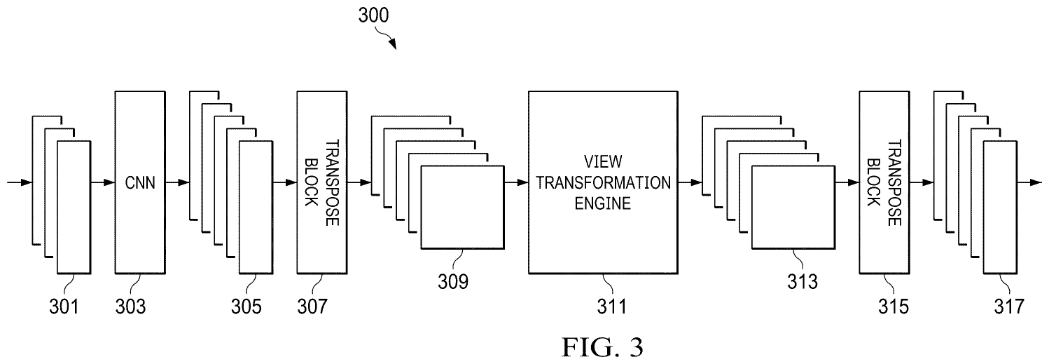

Now turning to the next figure, FIG. 3 illustrates operating environment 300 in an implementation. Operating environment 300 is representative of an example environment configurable to convert sensor data from a first perspective to a second perspective while executing the task of a neural network. For example, operating environment 300 may be representative of inference engine 109 of FIG. 1. Operating environment 300 includes, but is not limited to, input data 301, CNN 303, first perspective feature maps 305, transpose block 307, transposed feature maps 309, view transformation engine 311, second perspective feature maps 313, transpose block 315, and transposed feature maps 317.

Input data 301 represents sensor data which was captured in a first perspective by one or more sensors configured to collect the input data for executing a neural network. For example, input data 301 may be representative of several image matrices which store the pixel data of an image captured within a head-on perspective. More specifically, input data 301 may be representative of three image matrices storing the channel data of an RGB image captured within the head-on perspective, such that the first image matrix stores the red pixel data, the second image matrix stores the green pixel data, and the third image matrix stores the blue pixel data. For the purposes of explanation, image data will be discussed herein. This is not meant to limit the applications of operating environment 300, but rather to provide an example. In an implementation, input data 301 is provided as input to CNN 303.

CNN 303 is representative of a series of layers configured to extract features from input data 101 related to the task of the network. For example, if operating environment 300 is representative of a network configured to perform image classification, then CNN 303 may be configured to extract feature data related to the classification of an image. In an implementation, the nodes of CNN 303 include multiple feature channels configured to extract feature data from input data 301, such that the output of the feature channels is representative of a vector or matrix storing the extracted feature data. For example, the output node of CNN 303 may include five feature channels configured to extract feature data from input data 301, such that the output of the five feature channels includes first perspective feature maps 305.

First perspective feature maps 305 are representative of vectors or matrices configured to store feature data captured within the first perspective. For example, if input data 301 is representative of image data captured within the head-on perspective, then first perspective feature maps 305 may be representative of matrices configured to store feature data also captured within the head-on perspective. In an implementation, the nodes of CNN 303 produce a feature map for each of their feature channels. For example, if the output node of CNN includes five feature channels, then the output node of CNN 303 is configured to output five feature maps (i.e., first perspective feature maps 305). It should be noted that output node of CNN 303 is not limited to five feature channels and may instead comprise a numerous amount of feature channels, each configured to output a first perspective feature map, but for the purposes of explanation, five feature channels, and in turn five feature maps, will be discussed herein.

In an implementation, CNN 303 is configured to store the entries of first perspective feature maps 305 in memory based on the current dimensions of the feature maps. Meaning, CNN 303 is configured to store the entries of first perspective feature maps 305 nonlinearly in the memory. For example, after generating first perspective feature maps 305, CNN 303 is configured to store the data of the first feature map, then store the data of the second feature map, then store the data of the third feature map, then store the data of the fourth feature map, and then finally store the data of the fifth feature map continuously in memory.

It should be noted that each entry of first perspective feature maps 305 corresponds to an entry within input data 301. For example, if input data 301 is representative of an image matrix comprising nine entries, and CNN 303 produces five first perspective feature maps, each also comprising nine entries, then the first entry of each feature map corresponds to the first entries of input data 301, the second entry of each feature map corresponds to the second entries of input data 301, and so on. Thus, storing the data of first perspective feature maps 305 nonlinearly in memory means the corresponding entries of first perspective feature maps 305 are not stored together in a contiguous manner. Alternatively, storing the data of first perspective feature maps 305 linearly in memory means the corresponding entries of first perspective feature maps 305 are stored linearly. In an implementation, first perspective feature maps 305 are provided as input to transpose block 307.

Transpose block 307 is representative of one or more processing layers configured to perform a transpose operation on the output of CNN 303. For example, transpose block 307 may be representative of permutation layer 111 of FIG. 1. In an implementation, to perform the transpose operation of transpose block 307, transpose block 307 is configured to offload its transpose operation to an associated hardware accelerator. For example, after CNN 303 stores first perspective feature maps 305 in memory, the associated hardware accelerator may access the data of first perspective feature maps 305 and perform a transpose operation on the data of first perspective feature maps 305 to produce transposed feature maps 309.

Transposed feature maps 309 are representative of vectors or matrices configured to store the transposed data of first perspective feature maps 309. As such, transposed feature maps 309 are representative of vectors or matrices configured to store feature data within the first perspective. In an implementation, transpose block 307 is configured to store the entries of transposed feature maps 309 in memory based on the current dimensions of the feature maps. Meaning, transpose block 307 is configured to cause the associated hardware accelerator to store the entries of transposed feature maps 309 linearly in the memory. For example, if transposed feature maps 309 include five feature maps, each comprising nine entries, then the associated hardware accelerator is configured to store the data of the first entries of each transposed feature map, then store the data of the second entries, then store the data of the third entries, and so on, until the hardware accelerator stores the data of the ninth entries continuously in memory. Once stored, the data of transposed feature maps 309 may be provided as input to view transformation engine 311.

View transformation engine 311 is representative of one or more processing layers (e.g. view transformation layer 112) configured to transform the output of transpose block 309 from a first perspective to a second perspective. For example, view transformation engine 311 may be configured to convert the feature data of transposed feature maps 309 from a head-on perspective to a BEV perspective, or vice versa. In an implementation, to transform the data of transposed feature maps 309 from the first perspective to the second perspective, view transformation engine 311 is configured to apply a mapping function to each entry of transposed feature maps 309 to determine the appropriate location for the entries in the second perspective. Once determined, view transformation engine 311 is configured to execute a series of gather operations on the data of transposed feature maps 309 to generate second perspective feature maps 313.

It should be noted that each entry of transposed feature maps 309 is represented within a source location in the first perspective. As such, view transformation engine 311 is configured to, for each source location, determine the appropriate destination location within the second perspective based on the mapping function. For example, view transformation engine 311 may be configured to, for each entry of transposed feature maps 309, utilize the mapping function to determine the appropriate location for the entry within the second perspective. Once determined, view transformation engine 311 may execute a series of gather operations to convert the data of transposed feature maps 309 from the first perspective to the second perspective. For example, for each location within the second perspective, view transformation engine 311 may identify the feature data to be stored by the location, read the feature data from transposed feature maps 309, and write the feature data to the location within the second perspective. As a result, view transformation engine 311 outputs second perspective feature maps 313.

Second perspective feature maps 313 are representative of vectors or matrices configured to store feature data captured within the second perspective. For example, if view transformation engine 311 is configured to transform feature data from the head-on perspective to the BEV perspective, then second perspective feature maps 313 may be representative of matrices configured to store feature data captured within the BEV perspective.

In an implementation, view transformation engine 311 is configured to store the entries of second perspective feature maps 313 in memory based on the current dimensions of the feature maps. Meaning, view transformation engine 311 is configured to store the entries of second perspective feature maps 311 linearly in the memory. For example, if second perspective feature maps 311 include five feature maps, each comprising nine entries, then view transformation engine 311 is configured to store the data of the first entries of each feature map, then store the data of the second entries, and so on, until view transformation engine 311 stores the data of the ninth entries continuously in memory. Once stored, the data of second perspective feature maps 311 may be provided as input to transpose block 315.

Transpose block 315 is representative of one or more processing layers configured to perform a transpose operation on the output of view transformation engine 311. For example, transpose block 315 may be representative of permutation layer 113 of FIG. 1. In an implementation, to perform the transpose operation of transpose block 315, transpose block 315 is configured to offload its transpose operation to an associated hardware accelerator. For example, after view transformation engine 311 stores second perspective feature maps 313 in memory, the associated hardware accelerator may access the data of second perspective feature maps 313 and perform a transpose operation on the data of second perspective feature maps 313 to produce transposed feature maps 317.

Transposed feature maps 317 are representative of vectors or matrices configured to store the transposed data of second perspective feature maps 313. As such, transposed feature maps 317 are representative of vectors or matrices configured to store feature data within the second perspective. In an implementation, transpose block 315 is configured to store the entries of transposed feature maps 317 continuously in memory based on the current dimensions of the feature maps. Meaning, transpose block 315 is configured to cause the associated hardware accelerator to store the entries of transposed feature maps 317 nonlinearly in the memory.

For example, if transposed feature maps 317 include five feature maps, each comprising nine entries, then the associated hardware accelerator is configured to store the data of the first transposed feature map, then store the data of the second transposed feature map, then store the data of the third transposed feature map, then store the data of the fourth transposed feature map, and then finally store the data of the fifth transposed feature map continuously in memory. Once stored, the data of transposed feature maps 309 may be provided as input to a series of layers configured to form the output of the network within the second perspective.

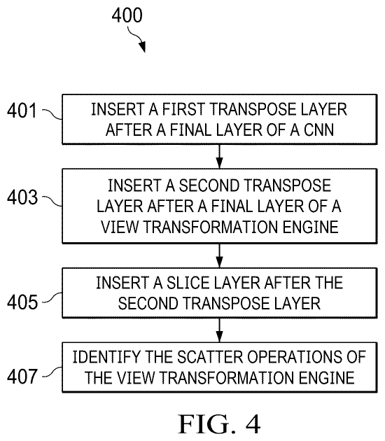

FIG. 4 illustrates compilation method 400 in an implementation. Compilation method 400 is representative of software, implemented at compile time, for improving the efficiency of a network configured to convert sensor data from a first perspective to a second perspective while performing a designated task. For example, compilation method 400 may provide a method to compile a network configured to convert sensor data from a head-on perspective to a BEV perspective while performing object detection. Compilation method 400 may be implemented in the context of program instructions that, when executed by a suitable computing system, direct the processing circuitry of the computing system to operate as follows, referring parenthetically to the steps in FIG. 4. For the purposes of explanation, compilation method 400 will be explained with the elements of FIG. 3. This is not meant to limit the applications of compilation method 400, but rather to provide an example.

To begin, processing circuitry associated with operating environment 300 inserts a first transpose layer after a final layer of a CNN (step 401). For example, if operating environment 300 is currently representative of a network consisting of CNN 303 and view transformation engine 311, then during the compilation of the network, the processing circuitry may be configured to insert transpose block 307 after the final layer of CNN 303. Next, the processing circuitry inserts a second transpose layer after a final layer of a view transformation block (step 403). For example, the processing circuitry may be configured to insert transpose block 315 after the final layer of view transformation engine 311. It should be noted that, the processing circuitry may be configured to simultaneously insert transpose blocks 307 and 309 during the compilation of operating environment 300.

Next, the processing circuitry is configured to insert a slice layer after the second transpose layer (step 405). For example, the processing circuitry may be configured to insert a slice layer after transpose block 315. The slice layer is representative of a processing layer configured to remove the entries from transposed feature maps 317 which are storing invalid feature data. Invalid feature data describes feature data which is represented within the first perspective but does not map to the second perspective. For example, invalid feature data may represent the data which CNN 303 deems useless within the context of the task operating environment 300 is configured to perform.

Finally, the processing circuitry is configured to identify the scatter operations to be executed by the view transformation block of the network (step 407). For example, the processing circuitry may identify the scatter operations of view transformation engine 311. A scatter operation is representative of a mapping operation which causes view transformation engine 311 to map entries from the source location to the destination location. For example, view transformation engine 311 may be configured to identify a source location within the first perspective, determine the destination location for the source location, read out the data from the source location, and write the data to the destination location.

In an implementation, after identifying the scatter operations of view transformation engine 311, the processing circuitry configures view transformation engine 311 to execute a gather operation for each of its scatter operations. A gather operation is representative of a mapping operation which causes view transformation engine 311 to map entries from the destination location to the source location. For example, view transformation engine 311 may be configured to identify a destination location within the second perspective, determine which source locations map to the destination location, read out the data from the source locations, and write the data to the destination location. In an implementation, to convert the scatter operations to gather operations, view transformation engine 311 is configured to generate a reverse-map table which stores the source locations for each destination location. In operation, view transformation engine 311 may reference the reverse-map table to determine, for each destination location, the one or more source locations to read-out data from.

Advantageously, converting the scatter operations of view transformation engine 311 to gather operations decreases the number of times view transformation engine 311 must read and write out data from memory. More specifically, the gather operations allow view transformation engine 311 to identify each source location of a destination location, and in one processing cycle, read out the data from the multiple source locations and write the data to the destination location. In contrast, scatter operations force view transformation engine 311 to, for each source location, read out the data from the source location and write the data to the destination location, thereby adding latency to the system.

As a result, compilation method 400 provides a technique to improve the efficiency of networks configured to convert sensor data from a first perspective to a second perspective while performing a designated task. More specifically, compilation method 400 provides a method to compile a network configured to convert sensor data from a first perspective to a second perspective while performing a designated task, which reduces the processing times, latency, and power consumption of the network, thereby improving the network's efficiency.

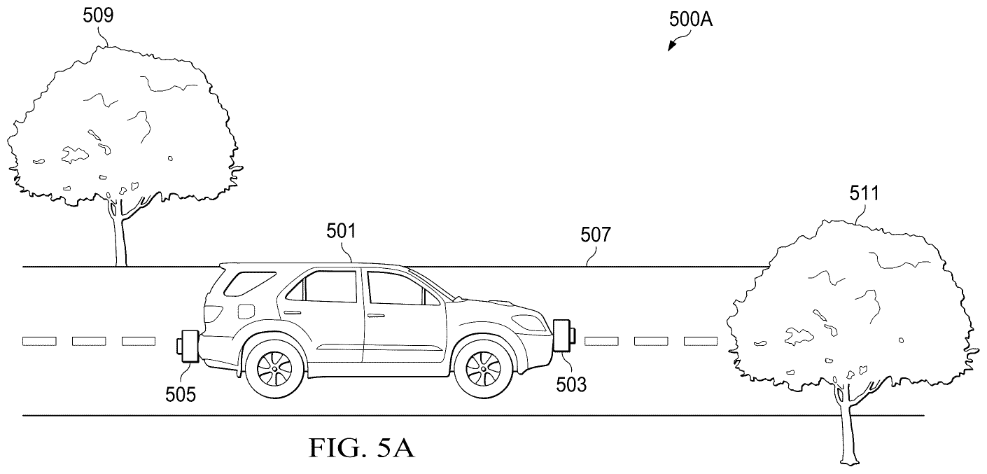

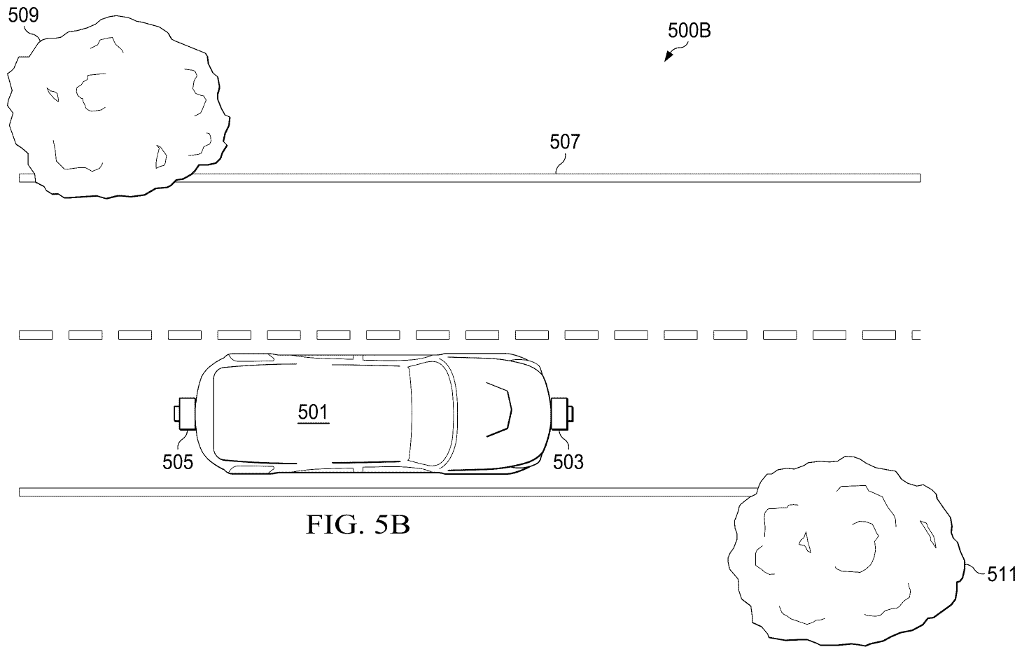

Now turning to the next figures, FIGS. 5A and 5B respectively illustrate operational scenarios 500A and 500B in an implementation. Operational scenarios 500A and 500B are representative of scenarios for converting sensor data from a first perspective to a second perspective in the context of a neural network configured to perform a designated task. More specifically, operational scenarios 500A and 500B illustrate a scenario for converting image data from a head-on perspective to a BEV perspective in the automotive context.

Turning to FIG. 5A, operational scenario 500A illustrates a scenario for collecting image data within the head-on perspective and converting the image data to a BEV perspective. Operational scenario 500A includes vehicle 501, road 507, and trees 509 and 511.

Vehicle 501 is representative of a car which includes circuitry configured to convert sensor data from the head-on perspective to the BEV perspective while executing the task of a neural network. For example, vehicle 501 may comprise circuitry (e.g., operating environment 100 or operating environment 300) configured to convert image data from the head-on perspective to the BEV perspective while performing object detection. Vehicle 501 includes, but is not limited to, camera 503 and camera 505.

Cameras 503 and 505 are representative of sensors configured to collect image data of an environment within the head-on perspective. Cameras 503 and 505 are further representative of sensors configured to collect input data for executing a neural network. In an implementation, cameras 503 and 505 provide image data in the form of matrices to a network configured to convert the image data of cameras 503 and 505 from the head-on perspective to the BEV perspective while performing a designated task.

In a brief operational scenario, cameras 503 and 505 are configured to begin collecting image data within a head-on perspective of the surrounding environment and provide the image data to processing circuitry of vehicle 501. For example, cameras 503 and 505 may collect head-on images of road 507, tree 509, or tree 511 and provide the images to the processing circuitry of vehicle 501. In response, the processing circuitry of vehicle 501 is configured to extract features from the image data, permute those features, transform the permuted features into the BEV perspective, permute the BEV perspective features, and form the output of the network. For example, the processing circuitry of vehicle 501 may be configured to execute view transformation method 200.

Now turning to FIG. 5B, operational scenario 500B illustrates operational scenario 500A within the BEV perspective. As such, operational scenario 500B also includes vehicle 501, road 507, and trees 509 and 511. In an implementation, operational scenario 500B represents the output of a network configured to convert image data from a head-on perspective to a BEV perspective while performing a designated task. For example, output of the network may be representative of an image which depicts operational scenario 500B.

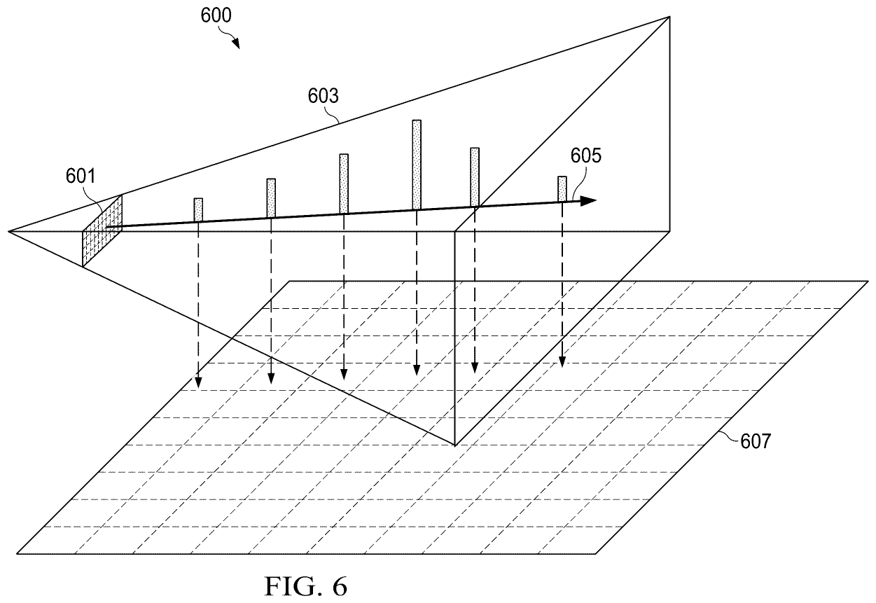

FIG. 6 illustrates operating environment 600 in an implementation. Operating environment 600 is representative of an example environment configured to map feature data from a first perspective to a second perspective. For the purposes of explanation, operating environment 600 is representative of an environment for converting feature data from a head-on perspective to a BEV perspective. This specification is not meant to limit the applications of operating environment 600, but rather to provide an example. Operating environment 600 includes feature map 601, depth projection 603, probability ray 605, and feature map 607.

Feature map 601 is representative of a matrix which stores extracted feature data represented within a head-on perspective. For example, feature map 601 may represent the output of a CNN (e.g., CNN 303) configured to extract feature data from an image matrix collected within the head-on perspective. Feature map 601 comprises multiple entries, such that the number of entries within feature map 601 is equal to the number of entries within the input matrix. For example, if the input matrix is representative of a 10×10 image matrix, then feature map 601 is also representative of a 10×10 matrix. In an implementation, to convert the data of feature map 601 from the head-on perspective to the BEV perspective, processing circuitry associated with operating environment 600 is configured to, for each entry of feature map 601, apply a mapping function to the entry within the head-on perspective to determine the location of the entry within the BEV perspective.

It should be noted that feature data captured within a head-on perspective represents the height and width of the input data, while feature data captured within a BEV perspective represents the width and the depth of the input data. Meaning, to convert the feature data of feature map 601 from the head-on perspective to the BEV perspective, the processing circuitry is configured to calculate the depth of each entry within the head-on perspective and map the calculated depth to the BEV perspective. For example, the processing circuitry may utilize depth projection 603 to calculate probability ray 605 for each entry of feature map 601.

Depth projection 603 is representative of a processing tool which allows processing circuitry associated with operating environment 600 to map an entry from the height and width perspective (i.e., head-on perspective) to the width and depth perspective (i.e., BEV perspective). For example, the processing circuitry may utilize depth projection 603 to generate probability ray 605 for each entry of feature map 601.

Probability ray 605 is representative of a vector which provides an indication of the probability of an entry from feature map 601 being located at varying depths in the BEV perspective. For example, probability ray 605 may include six entries, such that each entry is configured to store the probability of an entry from feature map 601 being located at a certain depth within feature map 607. In an implementation, the processing circuitry is configured to generate a probability ray for each entry of feature map 601 and determine the depth of an entry within feature map 601 by identifying the entry within feature map 607 that represents the entry with the highest probability.

Feature map 607 is representative of a matrix which stores extracted feature data represented within the BEV perspective. For example, feature map 607 may represent the output of view transformation engine 311. In an implementation, feature map 607 represents feature map 601 captured within the BEV perspective.

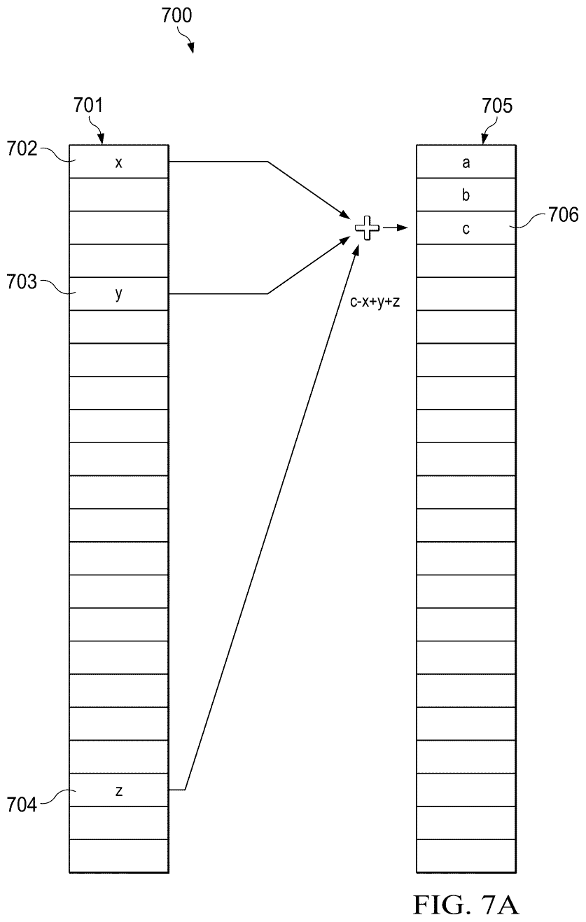

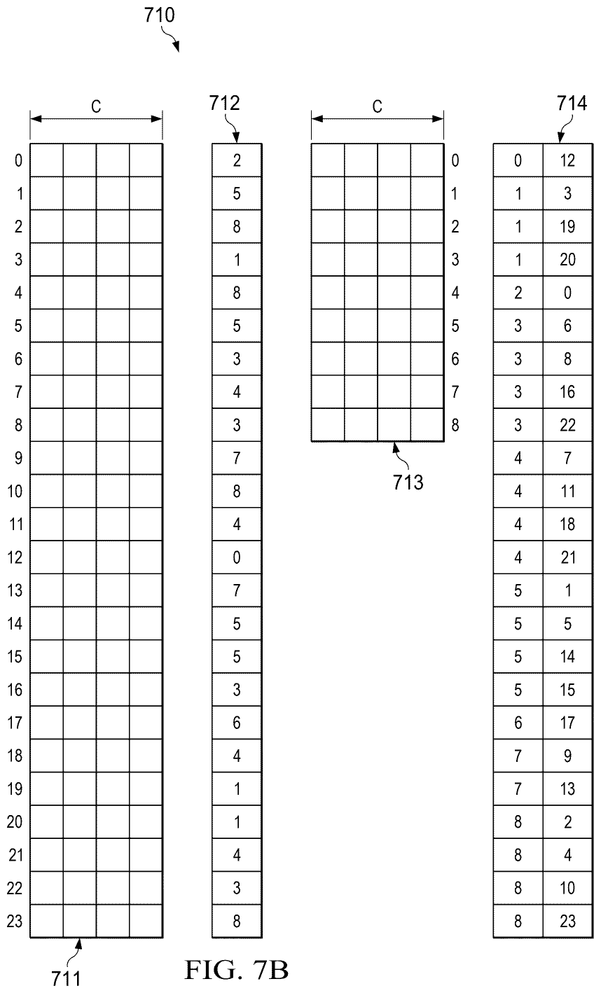

FIGS. 7A and 7B illustrate a mapping scenario in an implementation. For example, FIGS. 7A and 7B may be representative of a scenario for mapping feature data from a source location to a destination location in the context of a neural network. Now turning to FIG. 7A, mapping scenario 700 illustrates an operational scenario for performing gather operations in the context of a view transformation engine (e.g., view transformation engine 311) configured to convert sensor data from a first perspective to a second perspective. A gather operation is representative of a mapping technique which maps data from a destination location to a source location. Mapping scenario 700 includes source table 701 and destination table 705.

Source table 701 is representative of a table, stored in memory, which is configured to store first perspective feature data of an associated feature map. For example, source table 701 may be representative of a table which is configured to store the data of transposed feature maps 309. As such, source table 701 includes several entries, each configured to store the data of an associated entry within a first perspective feature map. Source table 701 includes, but is not limited to, entries 702, 703, and 704, which are depicted as x, y and z, respectively in FIG. 7A.

Entries 702, 703, and 704 are representative of entries configured to store transposed feature data captured within a first perspective. For example, entries 702, 703, and 704 may store feature data captured within a head-on perspective. In an implementation, a view transformation engine coupled to source table 701 and destination table 705 is configured to read-out the data of entries 702, 703, and 704, sum the data of the entries, and write the result of the summation to the appropriate entry within destination table 705.

Destination table 705 is representative of a table, stored in memory, which is configured to store second perspective feature data of an associated feature map. For example, destination table 705 may be representative of a table configured to store the data of second perspective feature maps 313. As such, destination table 705 also includes several entries, each configured to store the data of an associated entry within a second perspective feature map. Destination table 705 includes multiple entries including entry 706 (e.g., entry c).

Each entry of destination table 705 is representative of an entry configured to store feature data captured within a second perspective. For example, entry 706 may store feature data captured within a BEV perspective. In an implementation, a view transformation engine coupled to source table 701 and destination table 705 is configured to analyze entry 706 to determine the corresponding entries from source table 701 to read out data from. For example, the view transformation engine may determine that entry 706 is configured to store the data of entries 702, 703, and 704, based on the output of a mapping function. In response, the view transformation engine may read-out the data of entries 702, 703, and 704, sum the data of the entries, and store the result of the summation within entry 706. That is, entry c=x+y+Z.

In an implementation, to populate the entries of destination table 705, the view transformation engine is configured to, for each entry of destination table 705, identify the one or more entries of source table 701 to read-out data from, read-out the data from the identified entries, sum the data, and write the result of the summation to the appropriate entry within destination table 705. In other words, the view transformation engine is configured to perform a gather operation for each entry of destination table 705, such that the output of the view transformation engine is representative of a feature map captured within the second perspective.

Now turning to FIG. 7B, mapping scenario 710 illustrates another scenario for performing gather operations in the context of a view transformation engine (e.g., view transformation engine 311) configured to convert sensor data from a first perspective to a second perspective. Mapping scenario 710 includes source table 711, index table 712, destination table 713, and reverse map table 714.

Source table 711 and destination table 713 are representative of tables, stored in memory, which are configured to store feature data of a set of feature maps, such that source table 711 stores the feature data within a first perspective, and destination table 713 stores the feature data within a second perspective. For example, source table 711 may be representative of source table 701, and destination table 713 may be representative of destination table 705. In an implementation, source table 711 and destination table 713 include multiple entries, such that each entry is configured to store the channel data of an associated feature map. For example, source table 711 may include 24 entries, each capable of storing the channel data of four different first perspective feature maps, while destination table 713 may include nine entries, each also capable of storing the channel data of the four different feature maps.

In an implementation, to map the data from source table 711 to destination table 713, a view transformation engine (e.g., view transformation engine 311) coupled to source table 711 and destination table 713, is configured to apply a mapping function to each entry of source table 711 to determine the appropriate entry within destination table 713 for storing the feature data of source table 711. For example, the view transformation engine may, for each entry of source table 711, apply a mapping function to the entry to determine the appropriate entry within destination table 713 to index to, and in response, store the address of the appropriate entry within index table 712.

Index table 712 is representative of a table which stores the destination location for the entries of source table 711. For example, according to index table 712, the first entry (i.e., entry 0) of source table 711 maps to the third entry (i.e., entry 2) of destination table 713. In an implementation, a view transformation engine coupled to source table 711 and destination table 713, is configured to generate reverse map table 714, based on the data of index table 712.

Reverse map table 714 is representative of a table which stores the mappings between source table 711 and destination table 713. More specifically, reverse map table 714 represents a mapping table which designates the appropriate entry within destination table 713 for storing data of the corresponding entries within source table 711. In an implementation, a view transformation engine coupled to source table 711 and destination table 713, is configured to generate reverse map table 714 for each feature map that is supplied to the view transformation engine. Meaning, for each iteration of input data, the view transformation engine is configured to generate a reverse map table for the input data and utilize the reverse map table to execute gather operations when transforming the data of a feature map from a first perspective to a second perspective.

In a brief operational scenario, to map feature data from the source location to the destination location, a view transformation engine is configured to reference reverse map table 714 to determine the appropriate entries within source table 711 to read out data from. For example, for the first entry of destination table 713 (i.e., entry 0), the view transformation engine is configured to read out the data from the thirteenth entry of source table 711 (i.e., entry 12) and write the data to the first entry of destination table 713. Alternatively, for the second entry of destination table 713 (i.e., entry 1), the view transformation engine is configured to read out the data from the fourth, twentieth, and twenty-first entries of source table 711 (i.e., entries 3, 19, and 20), sum the data of the entries, and write the result to the second entry of destination table 713. In other words, the view transformation engine is configured to execute a gather operation for each entry of destination table 713, based on the data of reverse map table 714.

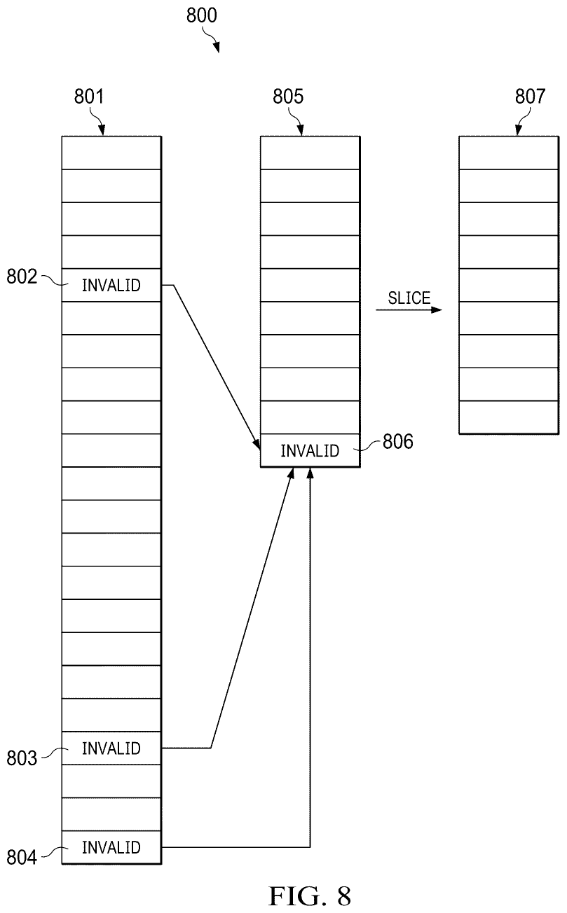

FIG. 8 illustrates slicing scenario 800 in an implementation. Slicing scenario 800 is representative of a scenario for removing invalid feature data from a feature map when converting the data of the feature map from a first perspective to a second perspective. For example, slicing scenario 800 may provide a scenario for removing invalid data from transposed feature maps 309 when converting transposed feature maps 309 to second perspective feature maps 313.

Invalid feature data describes data which is represented within the first perspective but is irrelevant to represent in the second perspective. For example, if a network is configured to perform object detection while converting image data from a head-on perspective to a BEV perspective, then the CNN of the network may be configured to generate multiple feature maps based on the image data, identify the entries of the feature maps which are storing invalid feature data, and flag the entries as invalid. A view transformation engine of the network may then remove the invalid entries when mapping the feature data of the feature maps from the head-on perspective to the BEV perspective. Slicing scenario 800 includes source table 801, destination table 805, and updated destination table 807.

Source table 801 is representative of a table, stored in memory, which is configured to store feature map data within a first perspective. For example, source table 801 may be representative of source table 701 or source table 711. In an implementation, source table 801 includes multiple entries, such that each entry is configured to store the data of an associated entry from a first perspective feature map. For example, source table 801 may include 22 entries which are configured to store the data of transposed feature maps 309. Source table 801 includes, but is not limited to, entries 802, 803, and 804.

Entries 802, 803, and 804 are representative of entries configured to store feature data captured within a first perspective. For example, entries 802, 803, and 804 may store invalid feature data captured within a head-on perspective. In an implementation, a view transformation engine coupled to source table 801 and destination table 805 is configured to read-out the invalid data of entries 802, 803, and 804, sum the data of the entries, and write the summed data to the appropriate entry within destination table 805.

Destination table 805 is representative of a table, stored in memory, which is configured to store second perspective feature data of an associated feature map. For example, destination table 805 may be representative of destination table 705 or destination table 713. In an implementation, destination table 805 includes multiple entries, such that each entry is configured to store the data of an associated entry from a second perspective feature map. For example, destination table 805 may include 10 entries which are configured to store the data of second perspective feature maps 313. Destination table 805 includes, but is not limited to, entry 806.

Entry 806 is representative of an entry configured to store invalid feature data captured within a second perspective. For example, entry 806 may store feature data which is captured within the head-on perspective but is irrelevant to be captured in the BEV perspective. In an implementation, a view transformation engine coupled to source table 801 and destination table 805 is configured to analyze entry 806 to determine the corresponding entries from source table 801 to read out data from. For example, the view transformation engine may reference a reverse map table (e.g., reverse map table 714) to determine that entry 806 is configured to store the data of entries 802, 803, and 804. In response, the view transformation engine may read-out the data of entries 802, 803, and 804, sum the data of the entries, and store the result of the summation within entry 806.

Once stored, a processing layer configured to remove the invalid data from the second perspective feature map is configured to slice off entry 806 from destination table 805 and as a result, generate updated destination table 807. Updated destination table 807 is representative of a table, stored in memory, which is configured to store valid feature data captured within a second perspective. For example, updated destination table 807 may include multiple entries which are configured to store the valid feature data of second perspective feature maps 313.

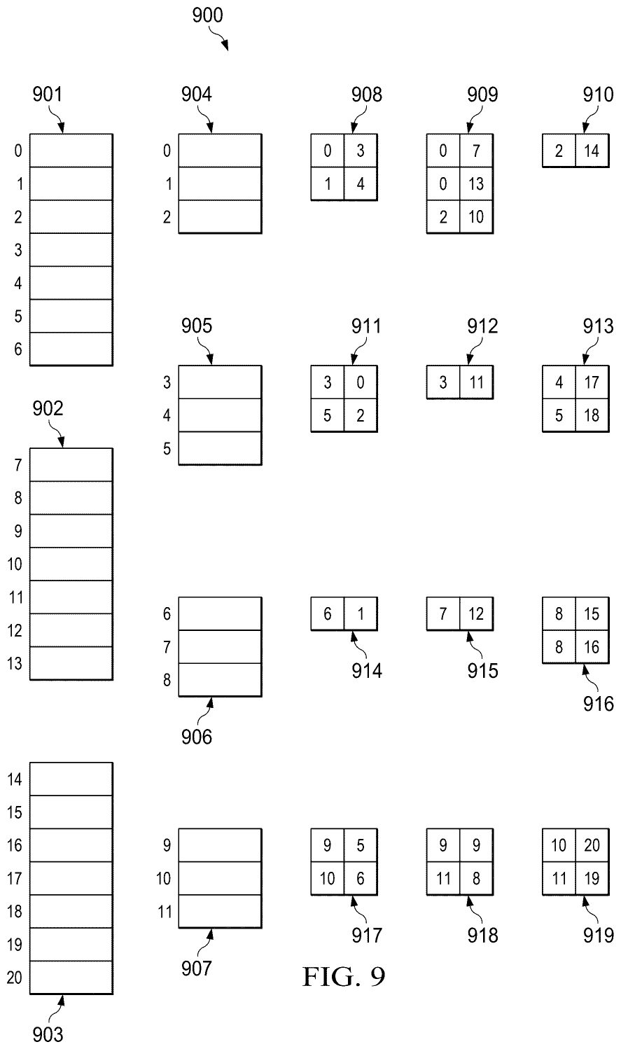

FIG. 9 illustrates mapping scenario 900 in an implementation. Mapping scenario 900 is representative of another scenario for mapping feature data from a source location to a destination location in the context of a neural network. For example, mapping scenario 900 may provide a scenario for mapping feature data from a head-on perspective to a BEV perspective in the context of a network configured to perform object detection. Mapping scenario 900 includes source tables 901-903, destination tables 904-907, and reverse map tables 908-919.

Source tables 901, 902, and 903 are representative of tables which are configured to store first perspective feature data of an associated feature map. More specifically, source tables 901, 902, and 903 are representative of tables configured to store sections of transposed feature maps which are represented within a first perspective. For example, source tables 901, 902, and 903 may be configured to store the transposed feature sections of transposed feature maps 309.

A transposed feature section is representative of a vector which includes multiple entries, such that each entry is configured to store the transposed feature data of a corresponding entry within a transposed feature map. For example, the transposed feature sections stored by source tables 901, 902, and 903 may be representative of the vectors which make up transposed feature maps 309. In an implementation, to generate the transposed feature sections, processing circuitry associated with mapping scenario 900 is configured to evaluate the size of a transposed feature map to determine if the size of the transposed feature map is larger than the size of an associated tensor, (e.g., the amount of multi-dimensional data of the associated transposed feature map). Meaning, the processing circuitry is configured to determine if the size of the transposed feature map (e.g., transposed feature map 309) exceeds the size of an associated on-chip memory.

In an implementation, if the processing circuitry determines that the on-chip memory of a system configured to convert sensor data from a first perspective to a second perspective does not comprise the bandwidth to store the transposed feature map, then the processing circuitry is configured to divide the transposed feature map into a number of transposed feature sections based on the size of the on-chip memory. Once divided, the processing circuitry may store the transposed feature sections in source tables 901, 902, and 903, such that source tables 901, 902, and 903 are stored in an off-chip memory of the system.

In operation, the processing circuitry of the system may transfer the data of a source table from the off-chip memory to the on-chip memory, and in response, map the data of the source table to the appropriate entry within destination tables 904, 905, 906, and 907. It should be noted that the amount of source tables is dependent on the number of transposed feature sections. For example, if a set of transposed feature maps are divided into five different sections, then the processing circuitry is configured to store each of the five different sections in five different source tables.

Destination tables 904, 905, 906, and 907 are representative of tables which are configured to store second perspective feature data of an associated feature map. More specifically, destination tables 904, 905, 906, and 907 are representative of tables configured to store sections of feature maps which are represented within a second perspective. For example, destination tables 904, 905, 906, and 907 may be configured to store the feature sections of second perspective feature maps 313.

A feature section is representative of a vector which includes multiple entries, such that each entry is configured to store the feature data of a corresponding entry within a second perspective feature map. For example, the feature sections stored by destination tables 904, 905, 906, and 907 may be representative of the vectors which make up second perspective feature maps 313. In an implementation, to generate the feature sections, processing circuitry associated with mapping scenario 900 is configured to perform a gather operation for each entry of destination tables 904, 905, 906, and 907 based on the data of reverse map tables 908-917.

Reverse map tables 908, 909, 910, 911, 912, 913, 914, 915, 916, and 917 are representative of tables which are configured to store the mappings between source tables 901-903 and destination tables 904-907. More specifically, reverse map tables 908, 909, and 910, respectively store the mappings between destination table 904 and source tables 901, 902, and 903, reverse map tables 911, 912, and 913 respectively store the mappings between destination table 905 and source tables 901, 902, and 903, reverse map tables 914, 915, and 916 respectively store the mappings between destination table 906 and source tables 901, 902, and 903, and reverse map tables 917, 918, and 919 respectively store the mappings between destination table 907 and source tables 901, 902, and 903. In an implementation, the number of reverse map tables is based on the number of source tables and destination tables. More specifically, the number of reverse map tables is equal to the number of source tables multiplied by the number of destination tables.

In an implementation, processing circuitry associated with mapping scenario 900 is configured to populate reverse map tables 908-917 based on the output of a mapping function. The mapping function is representative of an equation which allows the processing circuitry to determine the appropriate destination location within destination tables 904-907 for storing the data of source tables 901-903. For example, the processing circuitry may apply the mapping function to each entry of source tables 901-903, to determine the appropriate entry within destination tables 904-907 for storing the feature data. Meaning that the processing circuitry is configured to identify the location of feature data within the first perspective, determine the location of the feature data within the second perspective, and map the feature data from the first perspective to the second perspective.

In an implementation, source tables 901-903, destination tables 904-907, and reverse map tables 908-917 are stored in an off-chip memory, and when required by the processing circuitry, are supplied to an on-chip memory for access by the processing circuitry. For example, in the context of operating environment 100, source tables 901-903, destination tables 904-907, and reverse map tables 908-917 may be stored by memory 115, and when required by inference engine 109, are supplied to local memory 107. For the purposes of explanation, mapping scenario 900 will now be explained with the elements of FIG. 1, this is not meant to limit the applications of mapping scenario 900, but rather to provide an example.

To begin, processing circuitry 105 is configured to store the output of permutation layer 111 in memory 115. For example, processing circuitry 105 may store a set of transposed feature maps in memory 115, such that the set is represented within the first perspective and stored linearly within memory 115. Next, processing circuitry 105 is configured to divide the set into a number of transposed feature sections based on the size of local memory 107. For example, processing circuitry 105 may divide the set of transposed feature maps into three sections, and respectively store the three transposed feature sections within source tables 901, 902, and 903.

Once stored, processing circuitry 105 is configured to, for each entry of source tables 901, 902, and 903, determine the corresponding location of the entry within the second perspective. For example, processing circuitry 105 may apply a mapping function to each entry of source tables 901-903 to determine the appropriate entry within destination tables 904-907 for storing the data of source tables 901-903. Once determined, processing circuitry 105 stores the output of the mapping function within reverse map tables 908-917, such that reverse map tables 908-917 are currently stored in memory 115.

Next, processing circuitry 105 is configured to begin loading data from memory 115 to local memory 107 to allow view transformation layer 112 to transform the output of permutation layer 111 from the first perspective to the second perspective via a series of gather operations. For example, processing circuitry 105 may first load source table 901, destination table 904, and reverse map table 908 to local memory 107. In response, view transformation layer 112 may, for each entry of destination table 904, determine the feature data to be stored by the entry based on the data of reverse map table 908, read out the appropriate feature data from source table 901, and write the data to the entry. For example, for the first entry of destination table 904 (i.e., entry 0), view transformation layer 112 may determine that the first entry of destination table 904 is configured to store the data of the fourth entry of source table 901 (i.e., entry 3) based on the data of reverse map table 908. Next, view transformation layer 112 may read out the data from source table 901 and write the data to destination table 904.

In an implementation, after view transformation layer 112 gathers the appropriate data from source table 901, processing circuitry 105 is configured to store source table 901 and reverse map table 908 in memory 115, and load source table 902 and reverse map table 909 to local memory 107. In response, view transformation layer 112 is configured to perform another set of gather operations for the entries of destination table 904, based on the data of source table 902 and reverse map table 909. Once performed, processing circuitry 105 is configured to store source table 902 and reverse map table 909 in memory 115, and load source table 903 and reverse map table 910 to local memory 107. Next, view transformation layer 112 is configured to execute another set of gather operations for the entries of destination table 904, based on the data of source table 903 and reverse map table 910.

In an implementation, processing circuitry 105 and view transformation layer 112 repeat the above process for the remaining destination tables. Meaning that, for destination tables 905, 906, and 907, processing circuitry 105 is configured to load the appropriate source table and reverse map table to local memory 107 and view transformation layer 112 is configured to execute a series of gather operations with respect to the data of the reverse map table. Once executed, processing circuitry 105 is configured to store the source table and reverse map table in memory 115 and load the next source table and reverse map table to local memory 107 to be accessed by view transformation layer 112. Output of view transformation layer includes a second set of feature maps, represented within the second perspective.

It should be noted that processing circuitry 105 is configured to execute the above process for each iteration of data supplied to processing circuitry 105. Meaning that, for each iteration of sensor data collected by sensor interface 103, processing circuitry 105 is configured to generate the source tables, reverse map tables, and destination tables based on the collected sensor data.

Advantageously, mapping scenario 900 provides a scenario for mapping feature data which is based on the storage capacity of the on-chip memory. Meaning, mapping scenario 900 provides a scenario for mapping large amounts of feature data from a first perspective to a second perspective, by chunking the feature data into a number of transposed feature sections and executing a series of gather operations on the number of transposed feature sections to generate a number of feature sections represented within the second perspective.

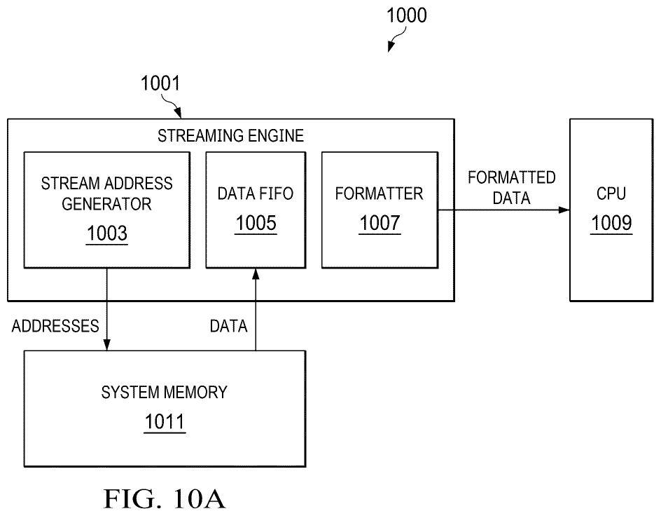

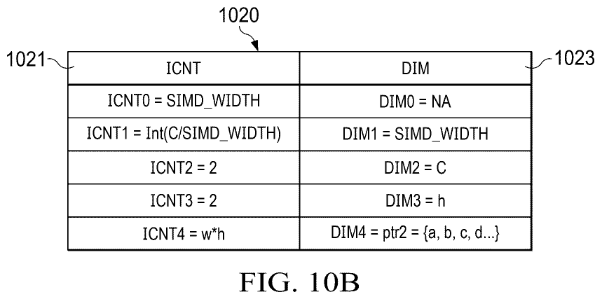

Now turning to the next figures, FIGS. 10A and 10B respectively illustrate system 1000 and table 1020 in an implementation. System 1000 is representative of an exemplary system configured to stream data from an off-chip memory to an on-chip memory in the context of a network configured to convert sensor data from a first perspective to a second perspective while performing a designated task. For example, system 1000 may be representative of a system configured to stream data from memory 115 to local memory 107. System 1000 includes streaming engine 1001, CPU 1009, and system memory 1011.

Streaming engine 1001 is representative of circuitry configured to stream data between an on- and off-chip memory. For example, streaming engine 1001 may be representative of a CPU, MCU, ASIC, or another processing device of the like configured to stream data between system memory 1011 and the on-chip memory of CPU 1009. Streaming engine 1001 includes stream address generator 1003, data FIFO 1005, and formatter 1007.

Stream address generator 1003 is representative of circuitry configured to identify the addresses within system memory 1011 to read-out data from or write data to. In an implementation, stream address generator 1003 is configured to identify the addresses of one or more source locations within system memory 1011, such that the one or more source locations are representative of locations that store transposed feature data which is represented within a first perspective. For example, the one or more source locations may be representative of locations configured to store the feature data of transposed feature maps 309. In an implementation, stream address generator 1003 is configured to access transposed feature sections from system memory 1011 and provide the transposed feature sections to data FIFO 1005.

Data FIFO 1005 is representative of circuitry configured to store data which was accessed from system memory 1011. For example, after stream address generator 1003 accesses the transposed feature sections from system memory 1011, the stream address generator is configured to store the transposed feature sections within data FIFO 1005. In response, data FIFO 1005 is configured to provide the transposed feature sections to CPU 1009 when requested by CPU 1009. In an implementation, when CPU 1009 forms a request to access data that is currently stored by data FIFO 1005, data FIFO 1005 is configured to provide the requested data to formatter 1007, and formatter 1007 is configured to format the data into a representation which may be supplied to CPU 1009.

Formatter 1007 is representative of circuitry configured to format data which was accessed from system memory 1011 into a representation that may be supplied to CPU 1009. For example, formatter 1007 may be configured to format transposed feature sections into a number of tables (i.e., source tables 901, 902, and 903), and supply the tables as input to a view transformation engine of CPU 1009.

CPU 1009 is representative of processing circuitry configured to execute the operations a of a neural network that is configured to convert sensor data from a first perspective to a second perspective while performing a designated task. For example, CPU 1009 may be representative of processing circuitry 1005 of FIG. 1. In an implementation, CPU 1009 is configured to request streaming engine 1001 to access data from system memory 1011 and supply the data to an on-chip memory of CPU 1009.

System memory 1011 is representative of one or more volatile or non-volatile computer-readable storage media including instructions, data, and the like. For example, system memory 1011 may be representative of SRAM, DRAM, flash memory, or another off-chip memory of the like (e.g., memory 115) configured to store the data of CPU 1009. In an implementation, the data stored by system memory 1011 includes sensor data and feature data. The sensor data stored by system memory 1011 is representative of data collected by the sensors of CPU 1009. More specifically, the sensor data represents the input data for the inference engine of CPU 1009. The feature data stored by system memory 1011 is representative of data which was extracted by the inference engine of CPU 1009. For example, the extracted data may represent first perspective feature maps (e.g., first perspective feature maps 305), transposed feature maps (e.g., transposed feature maps 309 and 317), or second perspective feature maps (e.g., second perspective feature maps 313).

In an implementation, streaming engine 1001 is configured to read-out data from system memory 1011 based on the data of table 1020. Now turning to the next figure, FIG. 10B illustrates table 1020 in an implementation. Table 1020 is representative of a table which stores indications on the method in which streaming engine 1001 should read out data from system memory 1011. Table 1020 includes counter column 1021 (ICNT) and dimension column 1023 (DIM).

Counter column 1021 is representative of a column which is configured to store counter values. A counter value is representative of a value which indicates the amount of data to be read-out by streaming engine 1001. For example, the counter value may instruct streaming engine 1001 to read out a transposed feature vector from a transposed feature map.

Dimension column 1023 is representative of a column which is configured to store dimension values. A dimension value is representative of a value which indicates the location in system memory 1011 to read out data from. For example, a dimension value may instruct streaming engine 1001 to read out the first set of entries from a transposed feature map. In an implementation, dimension column 1023 includes a programmable dimension value. The programmable dimension value is representative of a value which indicates multiple locations in system memory 1011 to read out data from. For example, if system memory 1011 is currently storing source table 901, then the programmable dimension value may indicate to streaming engine 1001 to read out data from the first, third, fifth, and seventh entries of source table 901.

Streaming engine 1001 may be configured to read multi-dimensional data continuously from memory, and in the example of table 1020, may be configured to read five-dimensional data continuously from memory. The first entry of counter column 1021 is “ICNT0=SIMD_WIDTH,” and the corresponding entry in dimension column 1023 is “DIM0=NA”, which means each of the data elements has designated width, SIMD_WIDTH, and a pitch of 1 (which, in the illustrated example, is the default dimension of streaming engine 1001, for which no programming value is needed; hence the designation “N/A” in dimension column 1023). More generally, in engineering terms, table 1020 illustrates a configuration to read data of dimension [w*h][2][2][int (C/SIMD_WIDTH)][SIMD_WIDTH], with pitch of dimension 0 as 1, pitch of dimension 1 as SIMD_WIDTH, pitch of dimension 2 as C, pitch of dimension 3 as h, and pitch of dimension 4 as a run time configurable option which can be read from another memory location pointed to by ptr2. In this example, the pitch of the highest dimension (DIM4) is configured at run time, and the pitches of each of the other dimensions is set at initialization time. Here, ‘C’ is length of a feature map stored continuously in memory, which feature map may be part of first or second perspective feature data as described, for example, in connection with FIG. 7B. The term “SIMD_WIDTH” represents a register size of CPU 1009.

Advantageously, the programmable dimension value allows CPU 1009 to perform bilinear interpolation. Bilinear interpolation is representative of a mapping technique which is used to map the fractional location of feature data from a first perspective feature map to a second perspective feature map. The fractional location of feature data within a first perspective feature map describes feature data which is not represented by a specific entry. In an implementation, to perform bilinear interpolation, CPU 1009 is configured to determine the fractional location of the feature data within the first perspective, and read out the feature data which surrounds the fractional location.

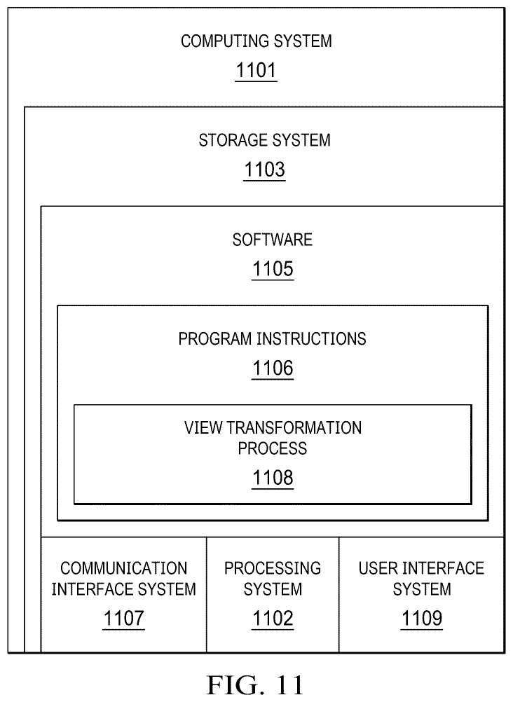

FIG. 11 illustrates an example computer system that may be used in various implementations. For example, computing system 1101 is representative of a computing device capable of efficiently converting sensor data from a first perspective to a second perspective within the context of a network configured to perform a designated task, as described herein. Computing system 1101 is representative of any system or collection of systems with which the various operational architectures, processes, scenarios, and sequences disclosed herein for mapping feature data from a first perspective to a second perspective while executing the task of a neural network may be employed. Examples of computing system 1101 include—but are not limited to—micro controller units (MCUs), embedded computing devices, server computers, cloud computers, personal computers, mobile phones, and the like.

Computing system 1101 may be implemented as a single apparatus, system, or device or may be implemented in a distributed manner as multiple apparatuses, systems, or devices. Computing system 1101 includes, but is not limited to, processing system 1102, storage system 1103, software 1105, communication interface system 1107, and user interface system 1109 (optional). Processing system 1102 is operatively coupled with storage system 1103, communication interface system 1107, and user interface system 1109. Computing system 1101 may be representative of a cloud computing device, distributed computing device, or the like.

Processing system 1102 loads and executes software 1105 from storage system 1103, or alternatively, runs software 1105 directly from storage system 1103. Software 1105 includes program instructions 1106, which includes view transformation process 1108 (e.g., view transformation method 200, compilation method 400). When executed by processing system 1102, software 1105 directs processing system 1102 to operate as described herein for at least the various processes, operational scenarios, and sequences discussed in the foregoing implementations. Computing device 1101 may optionally include additional devices, features, or functions not discussed for purposes of brevity.

Referring still to FIG. 11, processing system 1102 may comprise a micro-processor and other circuitry that retrieves and executes software 1105 from storage system 1103. Processing system 1102 may be implemented within a single processing device but may also be distributed across multiple processing devices or sub-systems that cooperate in executing program instructions. Examples of processing system 1102 include general purpose central processing units, graphical processing units, digital signal processing units, data processing units, application specific processors, and logic devices, as well as any other type of processing device, combinations, or variations thereof.

Storage system 1103 may comprise any computer readable storage media readable and writeable by processing system 1102 and capable of storing software 1105. Storage system 1103 may include volatile and nonvolatile, removable and non-removable, mutable and non-mutable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1103 may also include computer readable communication media over which at least some of software 1105 may be communicated internally or externally. Storage system 1103 may be implemented as a single storage device but may also be implemented across multiple storage devices or sub-systems co-located or distributed relative to each other. Storage system 1103 may comprise additional elements, such as a controller, capable of communicating with processing system 1102 or possibly other systems.

Software 1105 may be implemented in program instructions 1106 and among other functions may, when executed by processing system 1102, direct processing system 1102 to operate as described with respect to the various operational scenarios, sequences, and processes illustrated herein. In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1105 may include additional processes, programs, or components, such as operating system software, virtualization software, or other application software. Software 1105 may also comprise firmware or some other form of machine-readable processing instructions executable by processing system 1102.

In general, software 1105 may, when loaded into processing system 1102 and executed, transform a suitable apparatus, system, or device (of which computing device 1101 is representative) overall from a general-purpose computing system into a special-purpose computing system customized to support binary convolution operations. Indeed, encoding software 1105 (and view transformation process 1108) on storage system 1103 may transform the physical structure of storage system 1103. The specific transformation of the physical structure may depend on various factors in different implementations of this description. Examples of such factors may include, but are not limited to, the technology used to implement the storage media of storage system 1103 and whether the computer-storage media are characterized as primary or secondary, etc.

For example, if the computer readable storage media are implemented as semiconductor-based memory, software 1105 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1107 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1101 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method for converting sensor data from a first perspective to a second perspective, the method comprising:
processing the sensor data to produce a first set of feature maps associated with the first perspective;
transposing the first set of feature maps to produce a first set of transposed feature maps;
transforming the first set of transposed feature maps into a second set of feature maps associated with the second perspective; and
transposing the second set of feature maps to produce a second set of transposed feature maps.

2. The method of claim 1, wherein the first set of feature maps are stored nonlinearly in memory, wherein the first set of transposed feature maps are stored linearly in the memory, wherein the second set of feature maps are stored linearly in the memory, and wherein the second set of transposed feature maps are stored nonlinearly in the memory.

3. The method of claim 1, wherein prior to transforming the first set of transposed feature maps, the method further comprises:
grouping transposed entries of the first set of transposed feature maps into a number of transposed feature sections, wherein the number of transposed feature sections is based on a size of an associated tensor and a size of the sensor data in a first dimension; and
grouping entries of the second set of feature maps into a number of feature sections, wherein the number of feature sections is based on the size of the associated tensor.

4. The method of claim 3, wherein transforming the first set of transposed feature maps into the second set of feature maps comprises:
reading, from a mapping table, a destination location, wherein the destination location includes an entry from the number of feature sections;
determining, based on the mapping table, one or more source locations associated with the destination location, wherein the one or more source locations include one or more transposed entries from the number of transposed feature sections;
reading the one or more transposed entries from the one or more source locations;
summing the one or more transposed entries to generate a result; and
writing the result to the destination location.

5. The method of claim 4, wherein the method further comprises slicing an invalid input location from the number of feature sections.

6. The method of claim 1, wherein the method further comprises rendering the second set of transposed feature maps to generate an output associated with the second perspective.

7. The method of claim 1, wherein the first perspective comprises a head-on view of a scene, and wherein the second perspective comprises a birds-eye view (BEV) of the scene.

8. A non-transitory computer-readable medium having executable instructions stored thereon, configured to be executable by processing circuitry for causing the processing circuitry to:
process sensor data to produce a first set of feature maps associated with a first perspective;
transpose the first set of feature maps to produce a first set of transposed feature maps;
transform the first set of transposed feature maps into a second set of feature maps associated with a second perspective; and
transpose the second set of feature maps to produce a second set of transposed feature maps.

9. The non-transitory computer-readable medium of claim 8, wherein the first set of feature maps are stored nonlinearly in memory, wherein the first set of transposed feature maps are stored linearly in the memory, wherein the second set of feature maps are stored linearly in the memory, and wherein the second set of transposed feature maps are stored nonlinearly in the memory.

10. The non-transitory computer-readable medium of claim 8, wherein prior to transforming the first set of transposed feature maps, the instructions are executable by the processing circuitry for further causing the processing circuitry to:
group transposed entries of the first set of transposed feature maps into a number of transposed feature sections wherein the number of transposed feature sections is based on a size of an associated tensor and a size of the sensor data in a first dimension; and
group entries of the second set of feature maps into a number of feature sections, wherein the number of feature sections is based on the size of the associated tensor.

11. The non-transitory computer-readable medium of claim 10, wherein to transform the first set of transposed feature maps into the second set of feature maps, the instructions are executable by the processing circuitry for further causing the processing circuitry to:
read, from a mapping table, a destination location, wherein the destination location includes an entry from the number of feature sections;
determine, based on the mapping table, one or more source locations associated with the destination location, wherein the one or more source locations include one or more transposed entries from the number of transposed feature sections;
read the one or more transposed entries from the one or more source locations;
sum the one or more transposed entries to generate a result; and
write the result to the destination location.

12. The non-transitory computer-readable medium of claim 11, wherein the instructions are executable by the processing circuitry for further causing the processing circuitry to slice an invalid input location from the number of transposed feature sections.

13. The non-transitory computer-readable medium of claim 8, wherein the first perspective comprises a head-on view of a scene, and wherein the second perspective comprises a birds-eye view (BEV) of the scene.

14. A device comprising:
processing circuitry coupled to a streaming engine configured to access sensor data from memory, wherein the processing circuitry is configured to:
process the sensor data to produce a first set of feature maps associated with a first perspective;
transpose the first set of feature maps to produce a first set of transposed feature maps;
transform the first set of transposed feature maps into a second set of feature maps associated with a second perspective; and
transpose the second set of feature maps to produce a second set of transposed feature maps.

15. The device of claim 14, wherein the first set of feature maps are stored nonlinearly in the memory, wherein the first set of transposed feature maps are stored linearly in the memory, wherein the second set of feature maps are stored linearly in the memory, and wherein the second set of transposed feature maps are stored nonlinearly in the memory.

16. The device of claim 14, wherein prior to transforming the first set of transposed feature maps, the processing circuitry is further is configured to:
group transposed entries of the first set of transposed feature maps into a number of transposed feature sections wherein the number of transposed feature sections is based on a size of an associated tensor and a size of the sensor data in a first dimension; and
group entries of the second set of feature maps into a number of feature sections, wherein the number of feature sections is based on the size of the associated tensor.

17. The device of claim 16, wherein to transform the first set of transposed feature maps into the second set of feature maps, the processing circuitry is further configured to:
read, from a mapping table, a destination location, wherein the destination location includes an entry from the number of feature sections;
determine, based on the mapping table, one or more source locations associated with the destination location, wherein the one or more source locations include one or more transposed entries from the number of transposed feature sections;
read the one or more transposed entries from the one or more source locations based on a pointer value;
sum the one or more transposed entries to generate a result; and
write the result to the destination location.

18. The device of claim 17, wherein the processing circuitry is further configured to slice an invalid input location from the number of transposed feature sections.

19. The device of claim 14, wherein the first perspective comprises a head-on view of a scene, and wherein the second perspective comprises a birds-eye view (BEV) of the scene.

20. A method comprising:
inserting a first transpose layer after a final output layer of a convolutional neural network (CNN) wherein the first transpose layer is configured to perform a first transpose operation with respect to an output of the CNN;
inserting a second transpose layer after a final layer of a view transformation engine, wherein the second transpose layer is configured to perform a second transpose operation with respect to an output of the view transformation engine;
inserting a slice layer after the second transpose layer wherein the slice layer is configured to perform a slice operation with respect to an output of the second transpose layer; and
identifying one or more scatter operations of the view transformation engine.
